(19) United States
(12) Patent Application Publication
(10) Pub. No.: US 2015/0362106 A1
(43) Pub. Date: Dec. 17, 2015

(54) Coupling Retainer, Retainer Method, and Stabilized Coupling

(71) Applicant: Alex A. Laughlin, Granbury, TX (US)

(72) Inventor: Alex A. Laughlin, Granbury, TX (US)

(21) Appl. No.: 14/740,945

(22) Filed: Jun. 16, 2015

Related U.S. Application Data
(60) Provisional application No. 62/013,443, filed on Jun. 17, 2014.

(51) Int. Cl. F16L 23/00; F16L 33/28

(52) U.S. Cl. CPC F16L 23/003; F16L 33/28

(57) ABSTRACT

A retainer includes a ring body with one or more protector tabs, one or more flex regions, and first and second pinch features. The ring body lies in a retainer plane and forms a portion of a circular shape with a pinch opening defined between a first ring end and a second ring end. The protector tab or tabs are connected to the ring body and extend inwardly into an interior area defined by the ring body. Each flex region of the ring body may comprise a section along the length of the ring body which is relatively more flexible in the retainer plane than sections along the length of the ring body adjacent to the respective flex region. These first and second pinch features each form a grasping point by which the first ring end and second ring end may be moved more closely together to install the retainer within a circumferential inner groove of a fitting such as the groove between thread crests of a hammer union.

### CROSS-REFERENCE TO RELATED APPLICATION

Applicant claims the benefit, under 35 U.S.C. §119(e), of U.S. Provisional Patent Application No. 62/013,443 filed Jun. 17, 2014, and entitled “Threaded Coupling Retainer, Retainer Method, and Stabilized Threaded Coupling.” The entire content of this provisional application is incorporated herein by this reference.

### TECHNICAL FIELD OF THE INVENTION

The invention relates to a retainer for couplings such as the hammer nut of a hammer union. In particular, the invention is directed to a retainer which may be inserted into a thread of a hammer nut to retain the hammer nut relative to the adjacent tubing during shipping. The invention also encompasses methods of retaining a coupling in place on a length of tubing, and a tubing and coupling assembly in which the coupling is stabilized for shipment and handling of the assembly.

### BACKGROUND OF THE INVENTION

Some tubing connecting systems include a coupling which lies loosely on a length of tubing when the connecting system is not made up to form a connection. For example, a hammer union is made up of a threaded end which may be connected to one length of tubing, a nut end which may be connected to another length of tubing, and a hammer nut positioned loosely over the nut end. The hammer nut includes a female thread which matches the male thread of the threaded end. The two lengths of tubing are connected by the hammer union by placing the nut end and threaded end of the hammer union together in line and then threading the hammer nut onto the thread of the threaded end of the hammer union. As the hammer nut is threaded tightly on the threaded end of the hammer union, sealing faces associated with the nut end and threaded end of the hammer union are brought tightly together to produce a seal between opposing sealing faces.

A problem arises with hammer unions, which are very commonly used to make field connections in high-pressure tubing, in that the hammer nut rests loosely on the nut end of the hammer union and the adjacent tubing when the hammer union is not made up to form a connection. The loose hammer nut in this unconnected condition is free to slide along the adjacent tubing and rattle back and forth transversely to the axis of the tubing and nut end of the hammer union. This sliding and rattling of the hammer nut, particularly during shipping over rough terrain or in rough seas, can damage any finish on the tubing and leave the tubing unsightly and more susceptible to corrosion. It is also possible for the thread on the loose hammer nut to be damaged from this sliding and rattling during shipment and handling.

Another problem with hammer unions is that the exposed sealing faces of the nut end and threaded end of the union are susceptible to damage when the union is not made up. During shipping, for example, a piece of equipment or other material may impact one of the sealing faces and leave sufficient damage to prevent the hammer union from forming the desired seal. This is a particular problem in the high-pressure applications in which hammer unions are commonly used.

### SUMMARY OF THE INVENTION

The present invention includes a retainer that may be used to retain a threaded coupling or other circumferentially grooved fitting in a stabilized position relative to a length of tubing on which the threaded coupling or other fitting may be loosely received. The invention also encompasses a method for stabilizing such a coupling or fitting relative to a length of tubing and an assembly made up of a length of tubing, a threaded coupling or other fitting, and a retainer.

In one embodiment a retainer according to the invention includes a ring body with one or more protector tabs, one or more flex regions, and first and second pinch features. The ring body lies in a retainer plane and forms a portion of a circular shape with a pinch opening defined between a first ring end and a second ring end. The protector tab or tabs are connected to the ring body and extend inwardly into an interior area defined by the ring body. Each flex region of the ring body may comprise a section along the length of the ring body which is relatively more flexible in the retainer plane than sections along the length of the ring body adjacent to the respective flex region. The first and second pinch features are each located at a respective end of the ring body and each extend into the interior area defined by the circularly shaped ring body. These first and second pinch features each form a grasping point by which the first ring end and second ring end may be moved more closely together to decrease the diameter of the ring body sufficiently to allow the ring body to be positioned within a fitting and aligned with a circumferential groove of the fitting (such as a groove defined by adjacent crests of a female thread). In this position the retainer plane lies transverse to the longitudinal axis of the circumferential groove, and the pinch features can be released to allow the ring body to resiliently relax and thereby extend an outer edge of the ring body into the circumferential groove of the fitting.

The condition in which the outer edge of the ring body has been allowed to expand into the circumferential groove of the fitting may be referred to as the installed condition for the retainer. In this installed condition in the fitting, the protector tab(s) or other portions of the ring body are in position to contact an end surface of a length of tubing on which the fitting is positioned. Because the retainer is retained in the circumferential groove and cannot be removed easily without pinching the retainer ring ends together again so as to reduce the retainer ring diameter, the retainer ring is in position to contact the end surface of the length of tubing and prevent the fitting from sliding along the tubing. Thus the retainer ring may be used to stabilize a fitting (such as a hammer nut of a hammer union) on an end of a length of tubing (such as the nut end of a length of tubing for a hammer union) so that the length of tubing and fitting may be handled and transported without having the fitting slide relative to the tubing.

Another advantage of a retainer according to the invention is that portions of the protector tabs or portions of the ring body, or both, reside adjacent to the end surfaces of the length of tubing and protect that surface from contact which might cause damage. Thus where a retainer ring according to the invention is used to stabilize and retain a hammer nut on the nut end of a length of tubing, the retainer protects the sealing faces at the nut end of the tubing.

Some forms of the invention include an additional safety feature that helps prevent the retainer from being left in an installed position in a fitting while the fitting is made up on the tubing. Such a safety feature may comprise one or more side projections each extending from a face of the retainer transverse to the retainer plane. Each side projection has a base which is spaced apart axially inwardly from the outer edge of the ring body adjacent to the side projection so as not to interfere with the positioning of the outer edge of the ring body in a circumferential groove as described above. The side projections are long enough, that is, extend far enough from the retainer ring body so that the fitting (such as a hammer nut) cannot be threaded onto the male thread of the hammer union, or so that the side projections at least interfere with threading sufficiently to make it clear to an installer that the retainer must be removed in order to properly attach the fitting.

These and other advantages and features of the invention will be apparent from the following description of illustrative embodiments, considered along with the accompanying drawings.

### BRIEF DESCRIPTION OF THE DRAWINGS

FIG. 1 is a plan view of a retainer according to an embodiment of the invention.

FIG. 2 is a side view of the retainer shown in FIG. 1.

FIG. 3 is a view in perspective of the retainer shown in FIG. 1.

FIG. 4 is a view in perspective of a hammer nut end of a hammer union connector and a retainer according to an embodiment of the invention as the retainer is being positioned in the hammer nut.

FIG. 5 is a partially cut away view in perspective of the hammer nut end of the hammer union shown in FIG. 4, but with the retainer in an installed position in the hammer nut.

FIG. 6 is a view in perspective of a second embodiment of a retainer within the scope of the invention.

FIG. 7 is a side view of the retainer shown in FIG. 6.

### DESCRIPTION OF ILLUSTRATIVE EMBODIMENTS

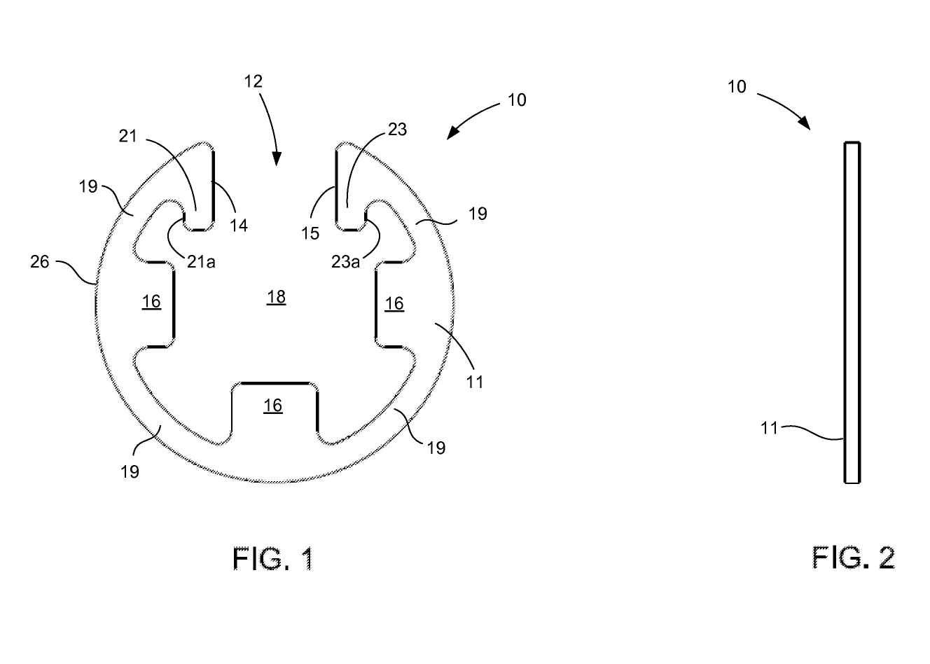

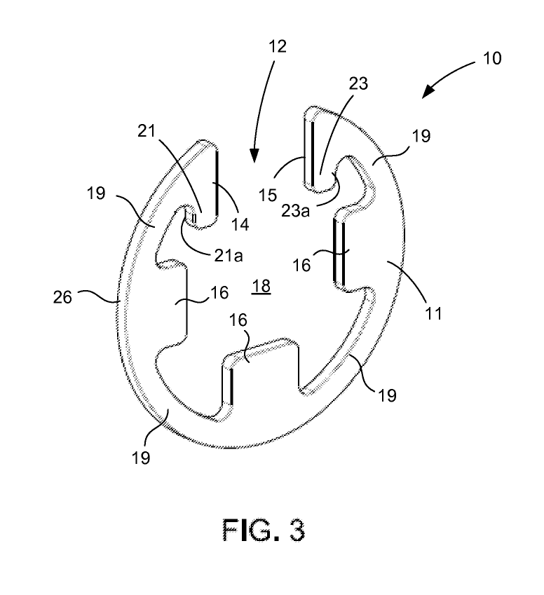

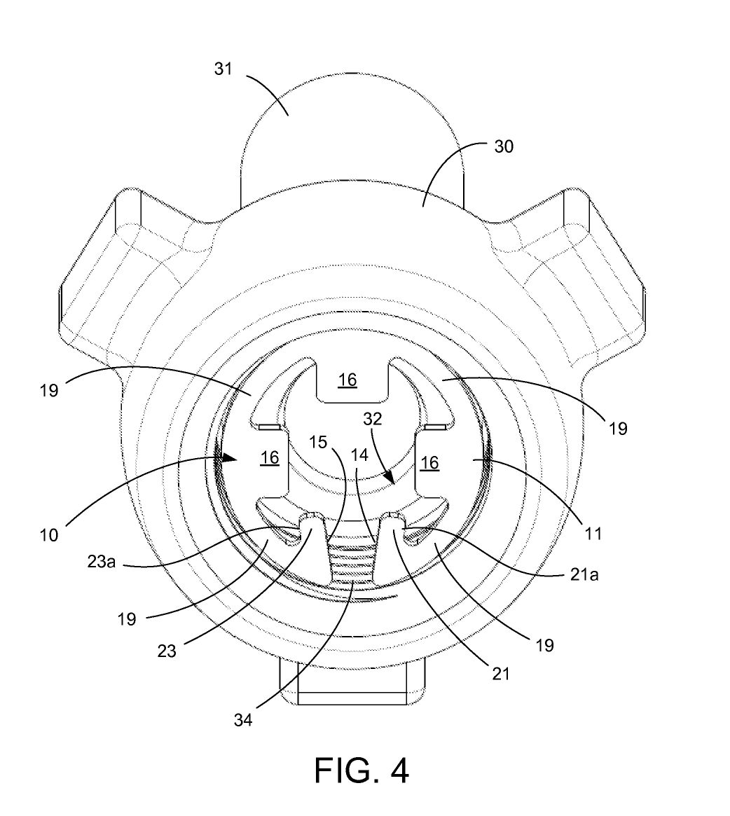

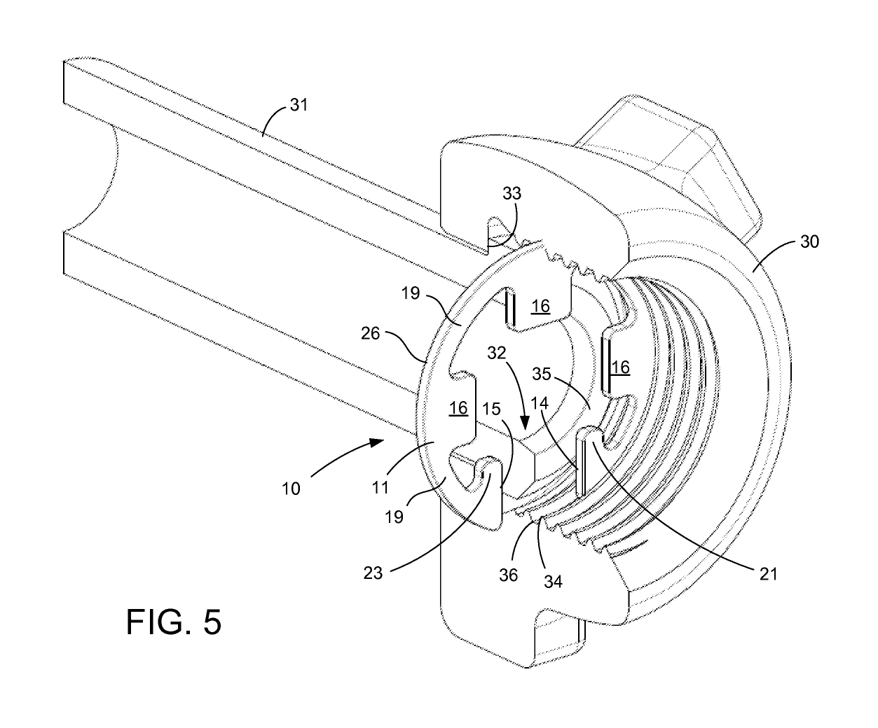

FIGS. 1-3 show a retainer 10 according to one form of the invention. As shown particularly in FIGS. 1 and 3, retainer 10 includes a ring body 11 lying in a retainer plane (parallel to the plane of the drawing in the plan view of FIG. 1) and forming a portion of a circular shape with a pinch opening 12 defined between a first ring end 14 and a second ring end 15. This embodiment includes three protector tabs 16 connected to the ring body 11 at spaced apart locations about the circumference of the ring body. Each protector tab 16 extends inwardly into an interior area 18 defined by the ring body 11. At least one flex region 19 is included in the ring body 11. The embodiment shown in FIG. 1 includes four flex regions 19. Each flex region 19 is relatively more flexible in the retainer plane than adjacent regions of the ring body 11. It should be noted that preferred forms of the invention include at least two protector tabs 16. However, it is possible (depending upon the nature of the material or materials from which the retainer 10 is formed and the configuration of the flex region or regions) for a single tab to extend through a wide enough angle to be effective for the function described below in connection with FIGS. 4 and 5.

Retainer 10 includes a first pinch feature 21 located at the first end 14 of the ring body 11 and a second pinch feature 23 located at the second end 15 of the ring body 11. The first and second pinch features 21, 23 each extend into interior area 18 defined by the circularly shaped ring body 11, and each form a grasping surface (surfaces 21a and 23a, respectively) by which the first ring end 14 and second ring end 15 may be pressed (pinched) more closely together to decrease the diameter of the ring body 11 sufficiently to allow the ring body to be positioned within a circumferential inner groove such as a groove of female threaded coupling (not shown in FIGS. 1 and 2) with the retainer plane lying transverse to the longitudinal axis of the circumferential inner groove. The first and second pinch features 21 and 23 may then be released to allow the ring body 11 to resiliently relax and thereby extend an outer edge 26 of the ring body 11 into the circumferential groove. The use of retainer 10 and a method according to the invention may be described with reference to FIGS. 4-5. In this example, the retainer is used in connection with a hammer union, and particularly to retain and stabilize a hammer nut 30 on a length of tubing 31 having the nut end (or “coupling end”) 32 of the hammer union with a diameter larger than an inner diameter of a shoulder of the hammer nut (shoulder 33 being visible only in FIG. 5). It should be appreciated that while a retainer according to the invention has particular application in connection with hammer unions, the invention is not limited to such applications. The description in connection with a hammer union is employed here simply as a convenient example application of an embodiment of the invention.

The method begins after the hammer nut 30 is positioned at the coupling end of the tubing 31, generally the position shown in FIG. 4. With the hammer nut 30 maintained at the coupling end of the tubing, the method includes placing the resilient circular ring body 11 in a retracted condition in which the diameter of the ring body in a plane thereof is reduced by reducing the pinch opening 12 between the two ring body ends 14 and 15. Placing the ring body 11 in the retracted condition may be accomplished by pressing against the grasping surfaces 21 a and 23a of the pinch features 21 and 23 to press the ring ends 14 and 15 relatively closer together. The reduction in diameter makes the outer diameter of the ring body 11 less than the crest 34 of a thread in the hammer nut 30 so that the retainer 10 can be inserted into the female threaded opening of the hammer nut 30 as shown in FIG. 4. While maintaining the ring body 11 in the retracted condition, the method includes placing the ring body 11 in an installation position in the hammer nut 30 with the plane of the ring body extending transverse to a longitudinal axis of the thread and with a face of the ring body adjacent to an end surface 35 at the coupling end of the tubing 31 (the end surface 35 being best shown in FIG. 5). FIG. 4 shows the ring body in the retracted condition at a point at which the retainer 10 has first been inserted into the volume defined by the female threaded inner surface of hammer nut 30. From the position shown in FIG. 4, the retainer 10 is simply inserted further into the hammer nut 30 to place the plane of the ring body 11 approximately perpendicular to the longitudinal axis of the hammer nut thread, with one face of the retainer adjacent to the end surface 35 at the coupling end of tubing 31 (perhaps but not necessarily with the face of the retainer touching the end surface 35). Once the ring body 11 in the retracted condition is in the installation position, the pinch features 21, 23 may be released to allow the ring body 11 to resiliently expand so that the outer edge 26 of the ring body extends (as shown in FIG. 5) into the area between thread crests in the hammer nut 30 and toward the thread root 36.

The condition in which the ring body 11 has been allowed to resiliently expand into the area between adjacent threads may be referred to as the retaining position. In this retaining position shown in FIG. 5, with the outer edge 26 of the ring body 11 received between adjacent thread crests of hammer nut 30, the protector tabs 16 have a surface that faces the end surface 35 at the coupling end of the tubing 31. Also, because the outer periphery of ring body 11 is positioned between adjacent thread crests, the ring body naturally remains in position and cannot be displaced easily without pinching the ring ends 14 and 15 together again to reduce the diameter of the ring body sufficiently to allow the ring body to clear the thread crests and be removed from the female threaded section. Thus in the retaining position shown in FIG. 5, the hammer nut 30 can only move to the left in the orientation of that figure until the end surface 35 of the tubing 31 contacts the facing surfaces of the protector tabs 16. This contact with the retainer 10, and particularly the protector tabs 16, prevents the hammer nut 30 from sliding down the length of the tubing 31 and thus stabilizes and retains the hammer nut at the end of the tubing. If the retainer 10 is placed in the retaining position deep enough into the hammer nut 30 so that the inner face of the protector tabs 16 actually contact the end surface 35 of the tubing 31, then the retainer can prevent substantially any movement of the hammer nut 30 longitudinally along tubing 31.

A retainer according to the present invention may be made of any suitable material such as any suitable plastic, metal, rubber, wood, or wood fiber composite, paper or paper fiber composite material that provides sufficient resiliency and strength to function as described above. It is also possible for the retainer to be formed from combinations of these materials, for example, a resilient metal or plastic material to form a core of the ring body 11, embedded within or attached to a paper, cardboard, or fiber board part that forms the protector tabs and perhaps the outer edge of the ring body. It is also possible for the resiliency described above to be provided in a retainer according to the invention by a spring element incorporated with other components which form the ring body 11 and other features.

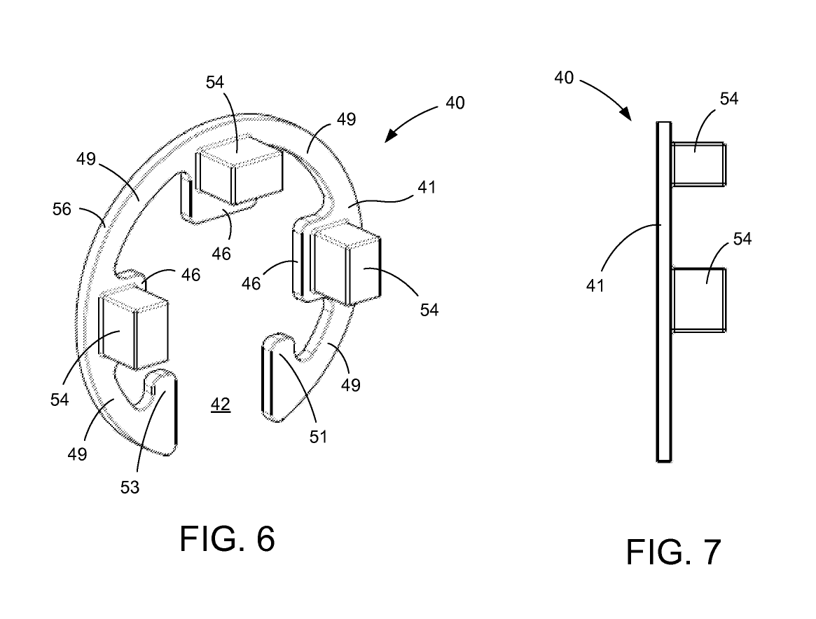

FIGS. 6 and 7 show an alternate form of retainer according to the present invention with incorporated safety features which prevent a coupling from being made or partially made with the retainer still in an installed position. A retainer 40 according to this alternate form of the invention includes a ring body 41, pinch opening 42, protector tabs 46, flex portions 49, and pinch features 51 and 53 similar to the corresponding elements shown in the embodiment of FIGS. 1-5. However, retainer 40 further includes projections 54 which extend from one face of the retainer. Projections 54 are shown as having a proximal end partially in the area of a respective protector tab 46 and partially in the area of an adjacent portion of the ring body. In any case, projections 54 should be spaced inwardly enough from the outer surface 56 of the ring body 11 so as not to interfere with the extension of the outer surface 56 into the area between adjacent threads of a coupling to an installation position as described above in connection with FIGS. 4 and 5.

Projections 54, or at least one of such projections, provides the benefit of preventing the retainer 40 from being inadvertently left in an installed position when the coupling is used to make a connection. That is, when retainer 40 is in an installed position similar to the position shown in FIG. 5 for retainer 10, the projections 54 would prevent the hammer nut from being threaded on to a male threaded counterpart of the hammer union. Either the projections 54 are long enough in the direction transverse to the plane of the retainer plane that the male threaded part cannot be received in the hammer nut, or if received at all, the projections prevent the hammer nut from being threaded on enough to appear to make a proper connection. Thus a worker noticing the improper/incomplete connection would be prompted to check the coupling and remove the retainer. Of course, once the retainer 40 is removed from the hammer nut, the hammer union may be connected properly.

The present invention encompasses any number, size, or shape of projections such as projections 54, as long as such projections provide the above-described function of preventing the coupling from being connected with the retainer 40 still installed, or at least making it obvious that the coupling is not properly made up.

It will be appreciated that a retainer according to the invention must be sized appropriately to fit a given female threaded coupling or other fitting having an inner circumferential groove. The outer edge of the ring body must have a dimension (both diameter in the relaxed state and thickness transverse to the plane of the ring body) that will allow the outer edge to extend into the space between adjacent thread crests of the female threaded coupling as shown particularly in FIG. 5, and the protector tabs must be sized to extend inwardly toward the center of the ring shape sufficiently to provide a surface facing at least a portion of the end of the tubing (the surface 35 or sealing face of the hammer union nut end in the illustrated examples), or perhaps a surface facing a shoulder near the end of the tubing in some cases. A protector tab may or may not cover the entire width of the tubing surface that the tab faces.

It should be noted that the invention is not limited to the illustrated application with a hammer nut of a hammer union.

As used herein, whether in the above description or the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term). The above described preferred embodiments are intended to illustrate the principles of the invention, but not to limit the scope of the invention. Various other embodiments and modifications to these preferred embodiments may be made by those skilled in the art without departing from the scope of the present invention.

1. A retainer including:
(a) a ring body lying in a retainer plane and forming a portion of a circular shape with a pinch opening defined between a first end of the ring body and a second end of the ring body;
(b) a protector tab connected to the ring body, the protector tab extending inwardly into an interior area defined by the ring body;
(c) a flex region of the ring body, the flex region comprising a section along the length of the ring body which is relatively more flexible in the retainer plane than sections along the length of the ring body adjacent to the flex region; and
(d) a first pinch feature located at the first end of the ring body and a second pinch feature located at the second end of the ring body, the first and second pinch feature each extending into the interior area defined by the circularly shaped ring body and each forming a grasping point by which the first end of the ring body and second end of the ring body may be moved more closely together to decrease the diameter of the ring body sufficiently to allow the ring body to be positioned within a circumferential groove of a fitting with the retainer plane lying transverse to the longitudinal axis of the circumferential groove, and then be released to allow the ring body to resiliently relax and thereby extend an outer edge of the ring body into the circumferential groove of the fitting.

2. The retainer of claim 1 further including one or more additional protector tabs connected to the ring body at spaced apart locations about the circumference of the ring body, each additional protector tab extending inwardly into the interior area defined by the ring body

3. The retainer of claim 1 further including one or more additional flex regions of the ring body, each additional flex region comprising a respective section along the length of the ring body which is relatively more flexible in the retainer plane than sections along the length of the ring body adjacent to the respective additional flex region.

4. The retainer of claim 1 wherein the section along the length of the ring body that comprises the flex region is relatively narrow in the retainer plane compared to sections along the length of the ring body adjacent to the flex region

5. The retainer of claim 1 wherein each pinch feature comprises a length of material extending into the interior area defined by the circularly shaped ring body and including a grasping surface residing in the retainer plane and facing away from the pinch opening of the ring body.

6. The retainer of claim 1 further including a side projection extending from a face of the retainer transverse to the retainer plane, the side projection having a base which is spaced apart axially inwardly from the outer edge of the ring body adjacent to the side projection.

7. The retainer of claim 6 further including one or more additional side projections, each additional side projection extending from a respective different part of the face of the retainer transverse to the retainer plane, each additional side projection having a respective base which is spaced apart axially inwardly from the outer edge of the ring body adjacent to the respective additional side projection.

8. A method of retaining a fitting with a circumferential inner groove on a length of tubing having a coupling end with a diameter larger than an inner diameter of a shoulder of the fitting, the method including:
(a) positioning the fitting at the coupling end of the tubing;
(b) placing a circular ring body in a retracted condition in which the diameter of the ring body in a plane thereof is reduced by reducing a pinch opening between two ring body ends, the reduction in diameter making the outer diameter of the ring body less than an axially inner end of the circumferential inner groove;
(c) while maintaining the ring body in the retracted condition and with the fitting maintained at the coupling end of the tubing, placing the ring body in an installation position in the fitting with the plane of the ring body extending transverse to a longitudinal axis of the circumferential inner groove of the fitting and with a face of the ring body adjacent to the coupling end of the tubing; and
(d) with the ring body in the installation position and the retracted condition, causing the ring body to expand so that an outer edge of the ring body extends into the circumferential inner groove of the fitting while portions of the face of the ring body or portions of a face of a protector tab connected to the ring body remain adjacent to the coupling end of the tubing.

9. The method of claim 8 wherein placing the circular ring body in the retracted condition includes applying a pinching force to opposing pinch features mounted at each end of the ring body formed by an opening in the ring body.

10. The method of claim 8 wherein the face of the protector tab remains adjacent to the coupling end of the tubing when the ring body expands, the protector tab being connected to the ring body and extending inwardly into an interior area defined by the ring body.

11. The method of claim 8 wherein the circular ring body includes a flex region comprising a section along the length of the ring body which is relatively more flexible in the plane of the ring body than sections along the length of the ring body adjacent to the flex region, and wherein placing the circular ring body in the retracted condition includes flexing the flex region.

12. A tubing and hammer nut assembly including:
(a) a length of tubing;
(b) a nut end of a hammer union positioned at one end of the tubing;
(c) a hammer nut positioned adjacent to the nut end of the hammer union; and
(d) a retainer positioned within the female thread of the hammer nut with a face of the retainer lying adjacent to a sealing face of the nut end of the hammer union, the retainer including,
(i) a ring body lying in a retainer plane and forming a portion of a circular shape with a pinch opening defined between a first end of the ring body and a second end of the ring body;
(ii) a protector tab connected to the ring body, the protector tab extending inwardly into an interior area defined by the ring body;
(iii) a flex region of the ring body, the flex region comprising a section along the length of the ring body which is relatively more flexible in the retainer plane than sections along the length of the ring body adjacent to the flex region; and
(iv) a first pinch feature located at the first end of the ring body and a second pinch feature located at the second end of the ring body, the first and second pinch feature each extending into the interior area defined by the circularly shaped ring body and each forming a grasping point by which the first end of the ring body and second end of the ring body may be moved more closely together to decrease the diameter of the ring body sufficiently to allow the ring body to be positioned within an area defined by the female threaded surface of the hammer nut with the retainer plane lying transverse to the longitudinal axis of the hammer nut, and then be released to allow the ring body to resiliently relax and thereby extend an outer edge of the ring body into a circumferential groove defined between adjacent crests of the thread within the hammer nut.

13. The tubing and hammer nut assembly of claim 12 further including one or more additional protector tabs connected to the ring body at spaced apart locations about the circumference of the ring body, each additional protector tab extending inwardly into the interior area defined by the ring body

14. The tubing and hammer nut assembly of claim 12 further including one or more additional flex regions of the ring body, each additional flex region comprising a respective section along the length of the ring body which is relatively more flexible in the retainer plane than sections along the length of the ring body adjacent to the respective additional flex region.

15. The tubing and hammer nut assembly of claim 12 wherein the section along the length of the ring body that comprises the flex region is relatively narrow in the retainer plane compared to sections along the length of the ring body adjacent to the flex region

16. The tubing and hammer nut assembly of claim 12 wherein each pinch feature comprises a length of material extending into the interior area defined by the circularly shaped ring body and including a grasping surface residing in the retainer plane and facing away from the pinch opening of the ring body.

17. The tubing and hammer nut assembly of claim 12 further including a side projection extending from a face of the retainer transverse to the retainer plane, the side projection having a base which is spaced apart axially inwardly from the outer edge of the ring body adjacent to the side projection.

18. The tubing and hammer nut assembly of claim 17 further including one or more additional side projections, each additional side projection extending from a respective different part of the face of the retainer transverse to the retainer plane, each additional side projection having a respective base which is spaced apart axially inwardly from the outer edge of the ring body adjacent to the respective additional side projection.
